(19) United States
(12) Patent Application Publication
(10) Pub. No.: US 2020/0090111 A1
(43) Pub. Date: Mar. 19, 2020

(54) INVENTORY MANAGEMENT AND SCHEDULING TOOL

(71) Applicant: MacLean-Fogg Company, Mundelein, IL (US)

(72) Inventors: Allison Heil, Arlington Heights, IL (US); Krzysztof Misztur, Crystal Lake, IL (US); Scott Masker, Waukesha, WI (US)

(73) Assignee: MacLean-Fogg Company, Mundelein, IL (US)

(21) Appl. No.: 16/135,733

(22) Filed: Sep. 19, 2018

(51) Int. Cl. G06Q 10/08; G06Q 10/06; H04W 4/33

(52) U.S. Cl. CPC G06Q 10/087; H04W 4/33; G06Q 10/06316; G06Q 10/083

(57) ABSTRACT

An inventory management and scheduling tool provides improved tracking of products as they are processed through a series of processing stations. The inventory management and scheduling tool further provides features for modifying workflows, selecting transporting options, and assigning alerts to appropriate personnel.

### TECHNICAL FIELD

This disclosure relates to an inventory management and scheduling tool (IMS tool) operating within an environment where product inventory is transported to different locations. The IMS tool includes technical improvements for tracking inventory within the environment, scheduling transport of the inventory within the environment, and providing modifications to a transfer schedule that incorporates deviations into predetermined manufacture and/or packaging workflows for the product. The IMS tool may further generate and utilize unique data structures to implement the features described herein to provide a technical improvement in the operation of a computing device implementing the inventory management. The IMS tool further includes detection and alerting features, as described in more detail herein. The IMS tool may be comprised of a combination of software, hardware, and/or circuitry for implementing the features described herein.

### BRIEF DESCRIPTION OF THE DRAWINGS

FIG. 1 shows an exemplary system and setting for utilizing an inventory management and scheduling tool.

FIG. 2 shows an exemplary computer architecture for a computer device configured to run the inventory management and scheduling tool.

FIG. 3 shows the exemplary system and setting shown in FIG. 1 utilizing the inventory management and scheduling tool according to an embodiment.

FIG. 4 shows an exemplary flow diagram of logic describing a process for utilizing the inventory management and scheduling tool.

FIG. 5 shows an exemplary graphical user interface (GUI) displaying options for inputting user commands related to confirming a pick up and drop off for a bin of product.

FIG. 6 shows a visualization of iterations that stage registers go through as product bins are processed through a workflow.

FIG. 7 shows the exemplary system and setting shown in FIG. 1 utilizing the inventory management and scheduling tool according to an embodiment.

FIG. 8 shows an exemplary flow diagram of logic describing a process for utilizing the inventory management and scheduling tool.

FIG. 9 shows an exemplary flow diagram of logic describing a process for utilizing the inventory management and scheduling tool.

### DETAILED DESCRIPTION

Apparatuses, systems, and methods are described that take advantage of the technological improvements offered by an inventory management and scheduling (IMS) tool. The IMS tool may be utilized within an environmental setting that includes, for example, a product manufacturing factory, or a product storing warehouse setting. The IMS tool may also be applied across different settings such as a manufacturing plant, product warehouse, food service facility, medical facility, or other setting that relies on tracking items to different locations within a known space.

The IMS tool utilizes a combination of predetermined product tracking workflows and product tracking data structures to more efficiently track products through a set of known workflows. The predetermined product tracking workflows may describe known manufacturing steps, as well as any corresponding manufacturing machines, that are used to bring a product from raw form to finished product. The predetermined product tracking workflows may also include known packaging steps, as well as any corresponding retrieval or packaging machines, and intervening steps and machines, to retrieve a product from a storage location and package the product for safe shipping. The predetermined product tracking workflows may also be modified to incorporate deviation processes, where the deviation processes may be selected from a collection of known deviation processes that apply to the type of predetermined product workflow.

The technological improvements include faster processing times, as well as conservation of computer resources (e.g., hardware and/or processing resources), which are achieved through the reduced reliance on bulky and resource draining hardware sensors. For example, the IMS tool utilizes existing tracking devices within an environment (e.g., manufacturing plant or storage warehouse) and specialized product tracking data structures (e.g., product count registers) to track products as they are picked up and dropped off at different stations according to a predetermined product tracking workflow. The actual tracking may be of a storage bin holding a number of products. So unlike other tracking systems, the IMS tool offers technological improvements that do not necessarily require barcode scanning or radio-frequency identification (RFID) sensor scanning to track items through a process within a space.

This system further provides an easy and efficient solution for modifying the predetermined product tracking workflow by inserting deviations, and/or removing existing processes. The IMS tool may further assign a product pick up or drop off ticket to a specific transporter (e.g., forklift and/or driver of the forklift) based on attributes of the transporter. The IMS tool may further be configured to detect maintenance issues within the environment and issue specifically tailored alert tracker announcements such as an announcement to notify individuals within the area utilizing the IMS tool of a quality or process issue. In some situations, these alert tracker announcements may be directed to specific personnel.

In this way, the IMS tool improves the computer capabilities of the devices involved to more efficiently (e.g., improved speed, less data handling, less resource utilization, better information flow, requires less user interaction) and accurately manage and track products moving within an environment.

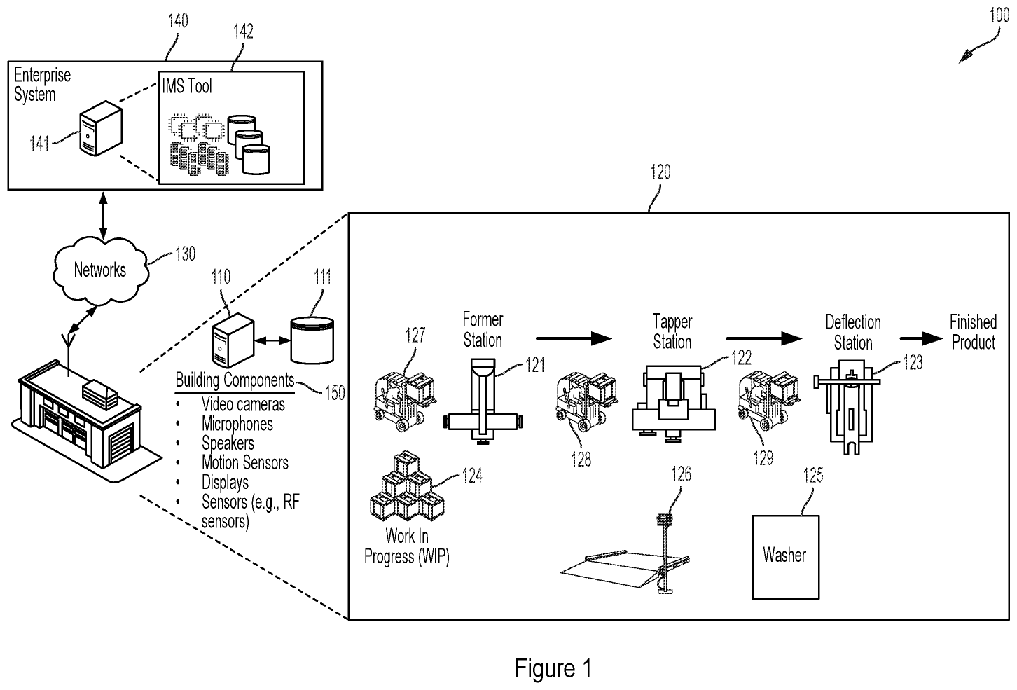

FIG. 1 illustrates an exemplary system 100 for implementing the IMS tool, where the system 100 includes a building 120 and an enterprise system 140. The building 120 includes multiple different station locations, where the stations correspond to a specific machine or an area where a collection of products (e.g., bins of product) are stored. For example, a work-in-progress (WIP) pile 124 includes a collection of one or more bins containing product, where the product contained in the bins may be the same or different. The exemplary product referenced in this disclosure is a fastener product such as a fastener nut having an internal thread for receiving a threaded bolt, although other products may also be used. A former station includes a former machine 121 used as a first step in producing the fastener nut product. The building 120 further includes a tapper station that includes a tapper machine 122 used as a second step in producing the fastener nut product. The building 120 further includes a deflection station that includes a deflection machine 123 used as a third step in producing the fastener nut product. In addition, the building 120 includes a scale 126 configured to weigh product, either individually or while the product is contained in a bin, as well as a washer 125 configured to wash the product. The scale 126 and washer 125 may be utilized between moving product between the former machine 121, tapper machine 122, or deflection machine 123. Bins may be transported within the building by forklifts, including a first forklift 127, a second forklift 128, and a third forklift 129. According to other embodiments, other types of transport options are also available such as unmanned aerial vehicles (UAVs) (e.g., drones).

The building further includes a computer device 110 and a database 111 accessible by the computer device 110. The computer device 110 may include the hardware, software, and/or circuitry for executing the IMS tool. The database 111 may include information referenced by the IMS tool. This information may include user profiles, building conditions, and/or predetermined product tracking workflows. A predetermined product tracking workflow identifies the specific steps, and machines, that are involved in manufacturing, or packaging, a specific product. For example, the predetermined product tracking workflow corresponding to the manufacturing of the fastener nut includes a description of the process for putting material through each of the former machine 121, then through the tapper machine 122, and finally though the deflection machine 123 (as well as any stops between the scale 126 and/or washer 125) to obtain the finished fastener nut product. The predetermined product tracking workflow may also be available in various degrees of granularity to provide, for example, the specific steps, and machines, that are involved in any of the individual steps.

The building 120 further includes various building components 150 that may be utilized by the IMS tool. These include one or more video cameras, one or more microphones, one or more speakers, one or more motion sensors, one or more displays, and/or one or more sensors (e.g., radio frequency (RF) sensors).

As described, the IMS tool may be executed on the computer device 110. The computer device 110 may be a type of central command computer for overseeing the operation of the IMS tool as it tracks product delivered to different stations within the building 120. In addition or alternatively, the IMS tool may be running, at least in part, as a web-based application 142 on a remote enterprise system 140 through a network 130. The enterprise system 140 may include an enterprise server computer 141 that allows a user remote access to the IMS tool after providing proper authentication for accessing the IMS tool remotely. The network 130 may be representative of one or more private, and/or public, networks defined over any predetermined and possibly dynamic internet protocol (IP) address ranges. According to some embodiments, the IMS tool may be implemented across a mesh network of decentralized computing devices.

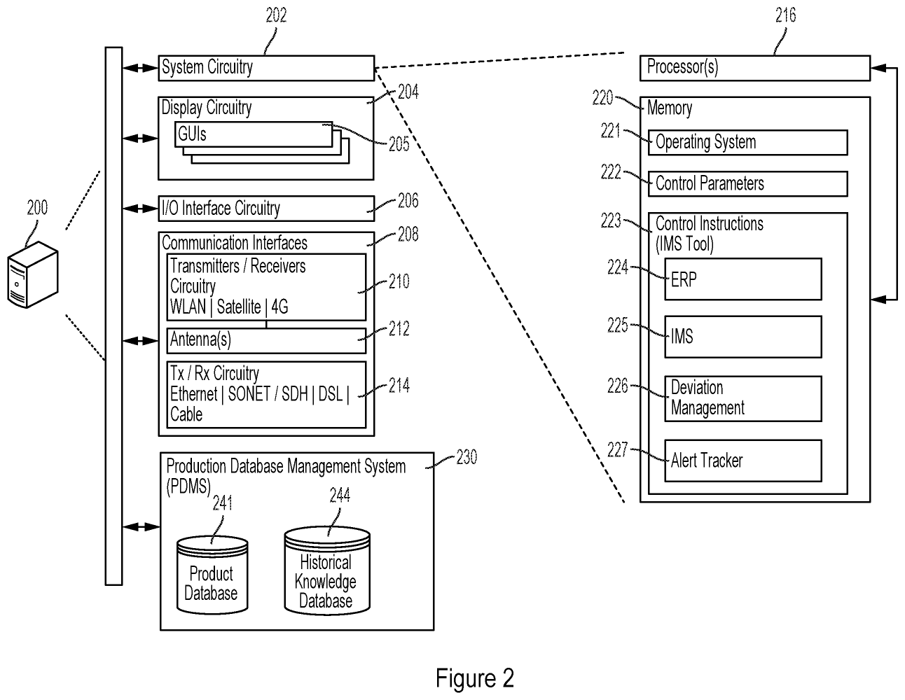

FIG. 2 illustrates an exemplary computer architecture 200 that is representative of a computing device such as any one of the computer device 110, or the server computer 141, on which the IMS tool is executed. The computer architecture 200 includes system circuitry 202, display circuitry 204, input/output (I/O) interface circuitry 206, and communication interfaces 208. The graphical user interfaces (GUIs) 205 displayed by the display circuitry 204 may be representative of GUIs generated by the IMS tool. The GUIs may be displayed locally using the display circuitry 204, or for remote visualization, e.g., as HTML, JavaScript, audio, and video output for a web browser or web-based application running on a local or remote machine. Among other interface features, the GUIs 205 may render displays of information or input commands generated by the IMS tool, as described further herein.

The GUIs 205 and the I/O interface circuitry 206 may include touch sensitive displays, voice or facial recognition inputs, buttons, switches, speakers and other user interface elements. Additional examples of the I/O interface circuitry 206 includes microphones, video and still image cameras, headset and microphone input/output jacks, Universal Serial Bus (USB) connectors, memory card slots, and other types of inputs. The I/O interface circuitry 206 may further include magnetic or optical media interfaces (e.g., a CDROM or DVD drive), serial and parallel bus interfaces, and keyboard and mouse interfaces. The I/O interface circuitry 206 may further include sensors such as RF sensors that are part of the computer architecture 200, or separate devices that are in communication with the computer architecture 200.

The communication interfaces 208 may include wireless transmitters and receivers (“transceivers”) 210 and any antennas 212 used by the circuitry of the transceivers 210. The transceivers 210 and antennas 212 may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces 208 may also include serial interfaces, such as universal serial bus (USB), serial ATA, IEEE 1394, lighting port, I²C, slimBus, or other serial interfaces. The communication interfaces 208 may also include wireline transceivers 214 to support wired communication protocols. The wireline transceivers 214 may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol. The communication interfaces 208 may communicate with remote computing devices via a network, such as the network 130.

The computer architecture 200 also includes, or in other embodiments communicates with, a production database management system (enterprise PDMS) 230. The PDMS 230 may be included as part of the enterprise system 140 illustrated in FIG. 1. The PDMS 230 includes a products database 241 that stores one or more product tracking workflows, product profiles (e.g., process for manufacturing or packaging specific products), and/or user profiles (e.g., forklift driver profiles). Each product profile may include product attribute information including one or more of the following: product name, product description, current status/state of product manufacture or packaging, as well as other product descriptive information. Each user profile may include user identification information such as a forklift driver's detailed skills, past experiences, current and previous roles within the enterprise organization, educational and training backgrounds, and/or prior participation in projects and roles in prior production processes. The PDMS 230 also includes a historical knowledge database 244 storing historical performance data (e.g., e.g., performance data for forklift drivers).

The system circuitry 202 may be representative of any combination of hardware, software, firmware, application programming interface, or other circuitry for implementing the features of the IMS tool described herein. For example, the system circuitry 202 may be implemented with one or more systems on a chip (SoC), application specific integrated circuits (ASIC), microprocessors, discrete analog and digital circuits, and other circuitry. The system circuitry 202 may implement any desired functionality of the IMS tool. As just one example, the system circuitry 202 may include one or more instruction processor 216 and memory 220.

The memory 220 stores, for example, control instructions 223 for executing the features of the IMS tool, as well as an operating system 221. In one implementation, the processor 216 executes the control instructions 223 and the operating system 221 to carry out any desired functionality for the IMS tool. For example, the control instructions 223 for the IMS tool includes a ERP portion 224, an IMS portion 225, a deviation management portion 226, and an alert tracker portion 227. Each component of the control instructions 223 may include the instructional logic for implementing the associated features of the IMS tool. The memory 220 also includes control parameters 222 that provide and specify configuration and operating options for the control instructions 223, operating system 221, and other functionality of the computer architecture 200.

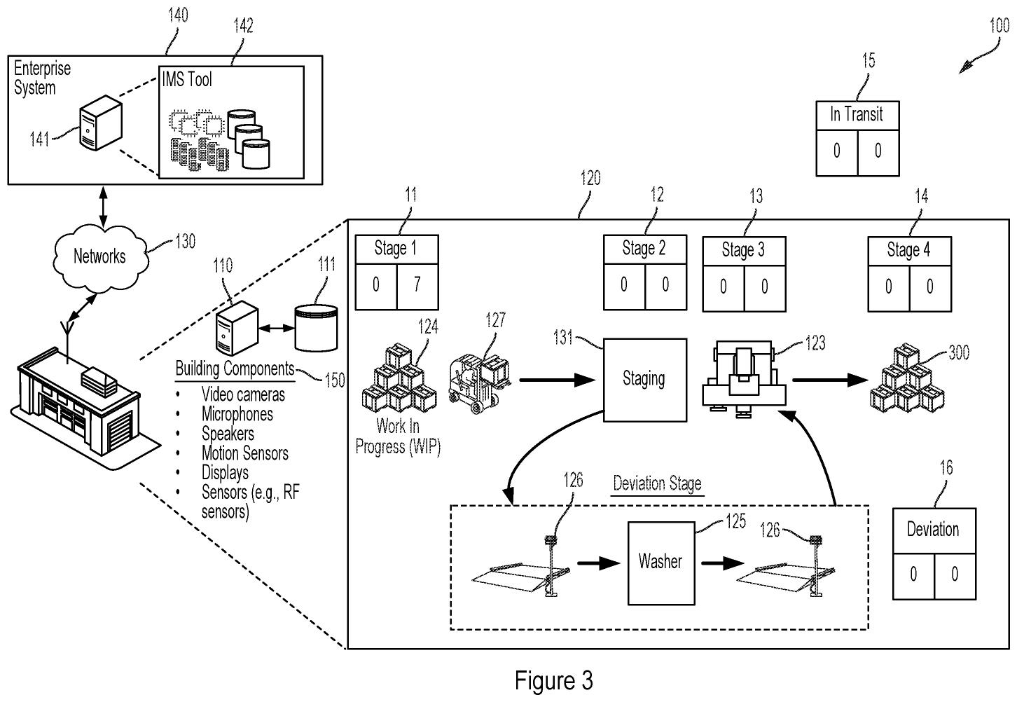

FIG. 3 illustrates the system 100, where specifically the IMS tool is shown to track products as they go through a predetermined product tracking workflow corresponding to the deflection machine 123. The predetermined product tracking workflow includes four stages represented by their respective stage registers: stage 1 corresponds to the WIP pile 124 of bins waiting to be picked up and is represented by a first stage register 11, stage 2 corresponds to a staging area 131 where bins are placed next to the deflection machine 123 and is represented by a second stage register 12, stage 3 (“running”) corresponds to products being deflected as they are processed through the deflection machine 123 and is represented by a third stage register 13, and stage 4 (“done”) corresponds to a finished product pile 300 where the post-deflected products are stored in bins and is represented by a fourth stage register 14. Each stage register counts a number of bins located at their respective stage. Presently, FIG. 3 illustrates the beginning of the workflow where all the bins are located at the WIP pile 124. In addition to the stage registers, the system 100 also includes an in-transit register 15 that tracks a number of bins that are in transit being transported between stages. The register count of the in-transit register 15 is decreased when a bin is confirmed to be placed in stage 4 (“done” finished product pile 300).

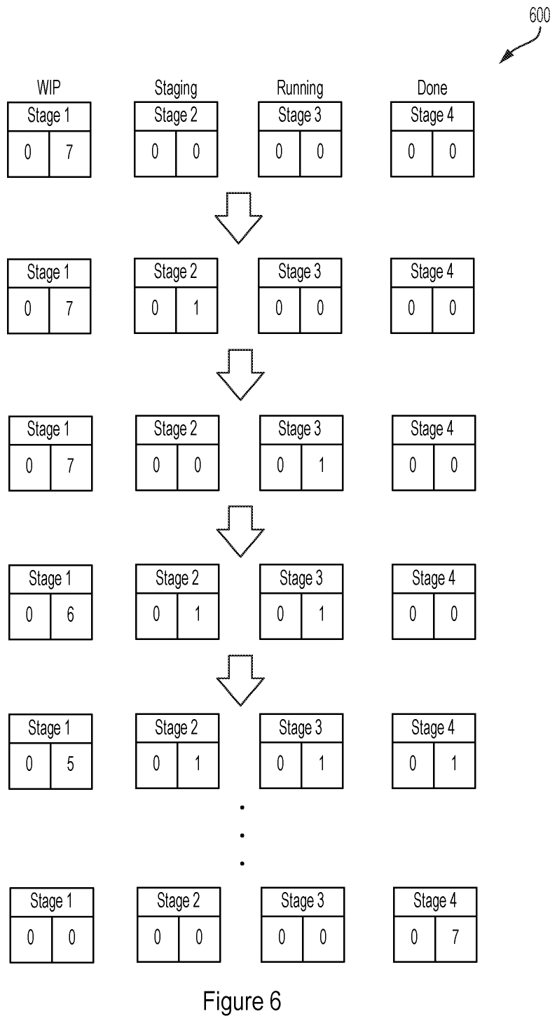

So the first stage register shows seven (7) bins are initially stored in the WIP pile 124. The remaining second stage register, third stage register, and fourth stage register show there are no products that have been processed to those stations. Throughout the implementation of the workflow, the values for the different stage registers will increase and decrease to reflect a number of bins at the respective station. However, at all times during the workflow, the stage register count value should add up to the total number of bins that are known to have been introduced into the workflow, which in this scenario is seven (7) bins. FIG. 6 illustrates a visualization 600 of the different stage registers though subsequent iterations of the workflow as the bins are transported through the subsequent stations. By the end of the workflow, all of the bins will end up at the finished product pile 300, as represented by the stage four register having a value of seven (7) indicating all seven bins are in the finished product pile 300.

A predetermined workflow may take bins from stage 1, to stage 2, to stage 3, and end at stage 4. According to some embodiments, in addition to the predetermined workflow, the bins may be put through an initial scale and wash step prior to entering the predetermined workflow where bins of product are washed and scaled by the washer 125 and scale 126. The bins may also be put through a subsequent scale and wash step after existing the predetermined workflow where bins of product are washed and scaled by the washer 125 and scale 126.

Further, according to some embodiments deviations steps may be inserted between any of the steps of the predetermined workflow. For example, FIG. 3 illustrates that between leaving the stage 2 and being dropped off at the deflection machine 123, bins may be scaled by the scale 126, washed by the washer 125, then re-scaled by the scale 126 after washing. The scaling and washing processes may be considered to be deviation steps from the otherwise predetermined manufacturing process. As the IMS tool has access to product weight information and bin weight information, the IMS tool determines a number of products contained in a particular bin after weighing the bin at the scale 126. The scale 126 may also be equipped with a scanning feature (e.g. bar code-based scanning, or RF sensor-based scanning) for scanning the bin before and/or after weighing the bin. In addition or alternatively, the washer 125 may be equipped with a scanning feature (e.g. bar code-based scanning, or RF sensor-based scanning) for scanning the bin before and/or after washing the bin.

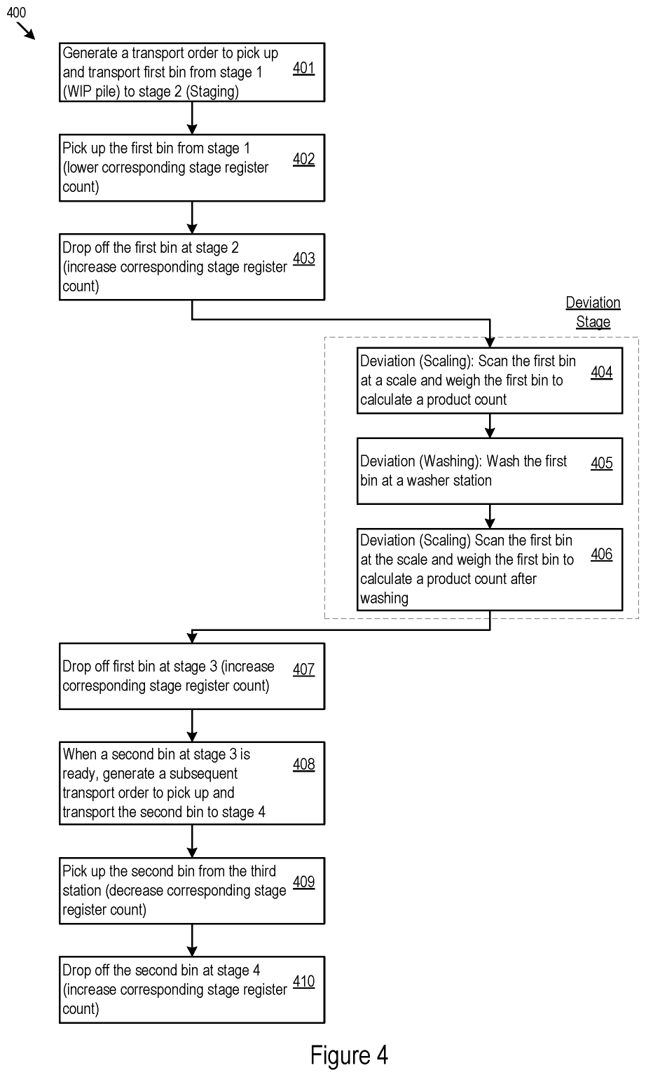

FIG. 4 illustrates a flow diagram 400 of logic describing a process implemented by the IMS tool for tracking bins of product through a workflow such as, for example, the product tracking workflow illustrated in FIG. 3. The product tracking workflow illustrated in FIG. 3 is comprised of a predetermined workflow taking a bin through stage 1, to stage 2, to stage 3, to stage 4, in addition to a deviation stage ordered by an operator of the IMS tool. The tasks that comprise the deviation stage is provided for exemplary purposes, as other operations may be ordered for the deviation stage.

At 401, the IMS tool initially generates a transport order to pick up and transport a first bin from stage 1 (e.g., WIP pile 124) to stage 2 (e.g., staging area 131). This transport order may be transmitted to any, or all, available forklifts to be claimed.

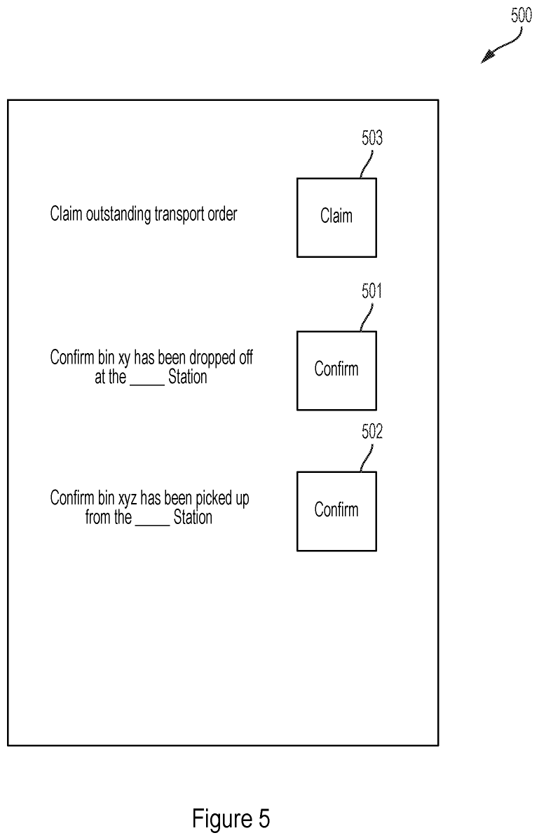

At 402, a forklift claims a work ticket corresponding to the transport order, and picks up the first bin from the WIP pile 124. When the forklift picks up the first bin from the WIP pile 124, a driver on the forklift may input a “claim” command to confirm the pickup. For example, FIG. 5 illustrates an exemplary GUI 500 that includes a “claim” button for a forklift operator to activate when they claim a transport order. According to some embodiments, the GUI 500 may also include optional fields for confirming the location of a bin drop off (e.g., drop off confirmation button 501), and/or for confirming the location of a pickup (e.g., pickup confirmation input button 502). The GUI 500 may be displayed on a tablet computer attached to the forklift. Upon receiving the confirmation that the first bin has been picked up from the WIP pile 124, the IMS tool recognizes the WIP pile now has one less bin, and a value of the first stage register is decreased accordingly. When the “claim” command is received, the IMS tool lowers the register count for the first stage register 11 (related to the WIP pile 12), and increases the register count for the in-transit register 15.

At 403, the forklift drops off the first bin at stage 2. When dropping off the first bin at stage 2, the IMS tool increases the register count for the second stage register 12.

Subsequent steps 404 to 406 are exemplary of a deviation stage that may be ordered. As the deviation stage is ordered, the IMS tool decreases the register count for the second stage register 12 when a transport order is claimed for transporting the first bin from stage 2 to the deviation stage.

At 404, the first bin enters a deviation stage when it is transported to the scale 126. At the scale 126, the first bin is scanned and weighed. The IMS tool determines a product count for the first bin based on the weight obtained from the scale 126 (e.g., the product count is obtained by dividing the weight of the bin (after removing the weight of the bin itself) with a known weight for a single product). When the first bin is dropped off at the scale 126, thus representing entering the deviation stage, the IMS tool increases a register count for a deviation register 16.

At 405, the first bin enters another deviation stage when it is further transported to the washer 125, where the product in the first bin is washed by the washer 125.

At 406, the first bin is further transported back to the scale 126, where the first bin is scanned and weighed again. The IMS tool compares the post-wash product count to the pre-wash product count to detect any lost product. When the first bin is claimed from the scale 126, thus representing exiting the deviation stage, the IMS tool decreases a register count for the deviation register 16.

At 407, the first bin is transported out of the deviation stage and back into the workflow by being dropped off at stage 3 (e.g., “running” at deflection machine 123). At stage 3, the product within the bin may be processed (e.g, deflected by the deflection machine 123). In addition, upon receiving confirmation that the first bin has been dropped off at stage 3, the IMS tool recognizes stage 3 now has one more bin, and a register count of the third stage register 13 is increased accordingly.

At 408, when a second bin is waiting for pickup from stage 3, the IMS tool is prompted to generate a subsequent transport order to pick up the second bin from stage 3, where the second bin contains product that has finished being processed through the third station. The subsequent transport order includes instructions to drop off the second bin at stage 4 (e.g., “done” finished product pile 300).

At 409, a forklift claiming a subsequent work ticket corresponding to the subsequent transport order will pick up the second bin from stage 3. Upon receiving confirmation that the second bin has been picked up from stage 3, the IMS tool recognizes stage 3 now has one less bin, and a register count of the third stage register 13 is decreased accordingly.

At 410, the forklift drops off the second bin at stage 4. Upon receiving confirmation that the second bin has been dropped off at stage 4, the IMS tool recognizes stage 4 now has one more bin, and a register count of the fourth stage register 14 is increased accordingly.

The IMS tool may track delivery times for each driver of the forklifts, and store this information into the driver's profile. The IMS tool may further track whether a transport was successful or unsuccessful (e.g., picked up on time within a predetermined window of time, delivered on time within a predetermined window of time from pick up confirmation, dropped off at correct destination), and store this information into the driver's profile.

The process described by flow diagram 400 may be repeated for each bin that is scheduled to work through the workflow.

Referring back to FIG. 11, the visualization 600 depicts a register shifting process as bins are transported and tracked through the various stages in a workflow that takes place in the building 120. When a transport order is “claimed” by a forklift operator, the respective stage register from which the bin is being picked up from will be decreased, and the known next stage register will be increased. This is continued until a bin is confirmed to be at a final stage (e.g., stage 4 “done” and in the finished product pile 300).

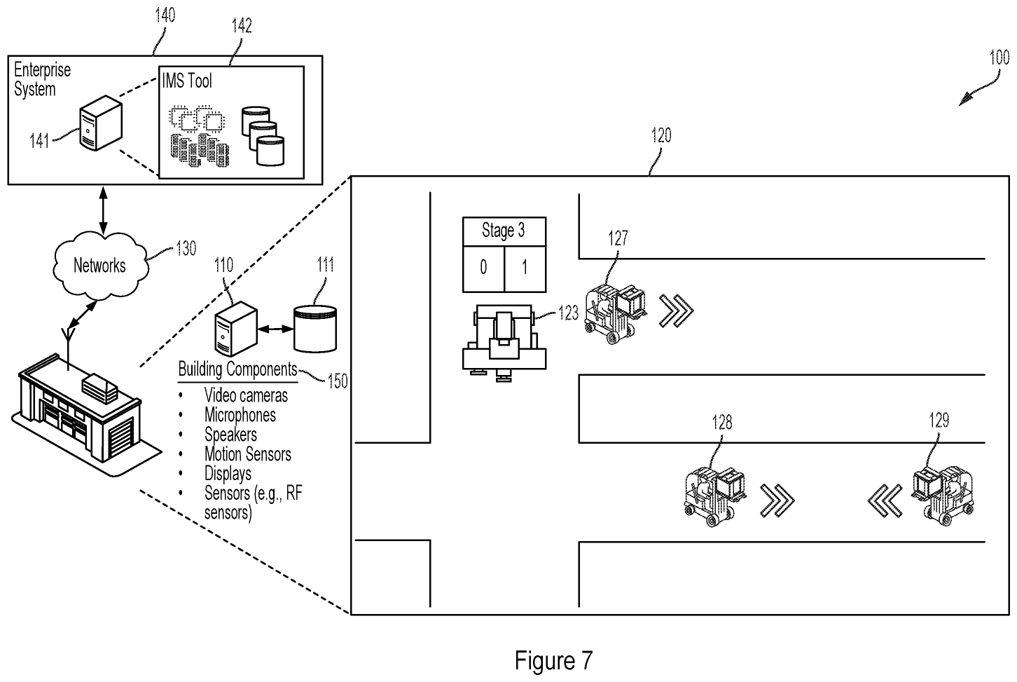

FIG. 7 illustrates the system 100, where specifically the IMS tool is shown to analyze available transport options within the building 120 for assigning a transport work order ticket requesting transport either to, or from, the deflection machine 123 (e.g., forklifts that are available for transporting a bin). After analyzing the transport options, the IMS tool selects a transport option that is determined to be “best” suited for the transport order based on the analysis. In this embodiment, transport options are represented by drivers of forklifts and/or the forklift itself, while other embodiments may include other types of transport options such as UAVs (e.g., drones).

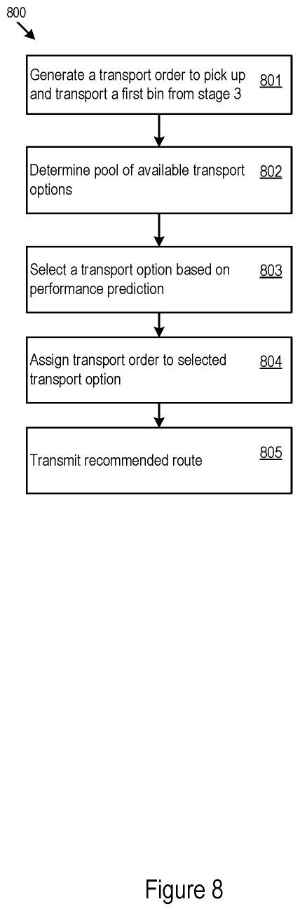

In the representative illustration of building 120 shown in FIG. 7, the first forklift 127 is shown to be closest to the deflection machine 123. The second forklift 128 is next closest in distance to the deflection machine 123, and the third forklift 129 is furthest in distance to the deflection machine 123. The IMS tool considers various different data points to then select a forklift to transmit the transport work order ticket, as described in more detail in the flow diagram 800 illustrated in FIG. 8.

FIG. 8 illustrates flow diagram 800 of logic describing a process for selecting a transport option to send a transport work order ticket. The transport work order ticket may be for pickup of a bin waiting for delivery to another station.

At 801, the IMS tool generates a transport order for pick up and transport of the first bin from the deflection machine 123 located at the third station. The transport order ticket may be initiated from a user input command. In addition or alternatively, the transport order ticket may be initiated according to a timing schedule accessed by the IMS tool that identifies when the first bin is ready for pick up after being processed by the deflection machine 123.

At 802, the IMS tool determines a pool of available transport options. To determine the pool of available transport options, the IMS tool may determine an operational status of forklifts within the building 120, determine a location of the forklifts in relation to the deflection machine 123, or obtain other attributes of the forklifts. Then, the IMS tool may determine the pool of available transport options to be forklifts determined to be in an operational status, forklifts that are not currently transporting a bin, forklifts that are within a predetermined distance from the deflection machine 123 located at the third station, or a combination thereof. In addition or alternatively, other considerations may be taken by the IMS tool when determining the pool of available transport options.

At 803, the IMS tool selects, from the pool of available transport options, a transport option based on a predicted performance of the selected transport option. The predicted performance of the transport option may consider one or more of the following attributes: forklift's distance from the deflection machine 123, forklift's capability to handle the bin (e.g., is the forklift rated to carry the weight of the bin), or a past performance of the forklift driver. For example, the IMS tool may select the first forklift that is closest to the deflection machine 123. The IMS tool may further select the forklift that is closest to the deflection machine 123 that is rated to carry the weight of the bin. The IMS tool may further consider attributes of the respective forklift driver, and select the forklift having a driver with the highest past performance score. The driver's performance score may consider the driver's timeliness in delivering bins, as well as a ratio of successful transports versus unsuccessful transports. Drivers having greater timeliness and a greater ratio of successful transports versus unsuccessful transports will be given higher performance scores.

At 804, the IMS tool assigns the transport order ticket to the selected transport option. This may include transmitting the transport order ticket to a tablet computer attached to the selected forklift for the respective driver to view.

At 805, the IMS tool transmits a recommended route to the selected transport option. For example, the IMS tool may consider traffic within the building 120, and determine a recommended route that is predicted to result in the shorted travel time for the transport option to accomplish their task.

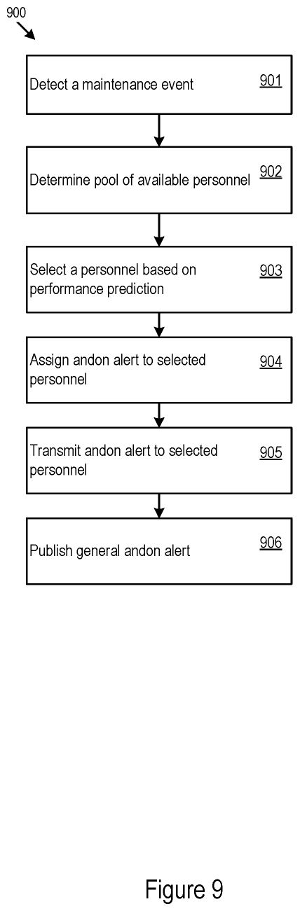

FIG. 9 illustrates flow diagram 900 of logic describing a process for selecting a personnel to send an alert tracker ticket. The alert tracker ticket is initiated by a detected maintenance issue, and directed to targeted personnel determined to be adapted to address the maintenance issue event.

At 901, the IMS tool detects a maintenance event. The maintenance event may be initiated by a user input that directly alerts the IMS tool of an issue (e.g., malfunctioning machine). The maintenance event may also be initiated by an automatic detection of a maintenance event by the IMS tool itself. For example, the IMS tool may identify a scheduled maintenance check for the deflection machine 123, and determine this to be a maintenance event. The IMS tool may also monitor certain machines within the building 120, and when an issue with the monitored machine is detected, the IMS tool may determine this to be a maintenance event.

At 902, the IMS tool determines a pool of available personnel for addressing the maintenance issue event. To determine the pool of available personnel, the IMS tool may determine a status of personnel (e.g., currently working, on vacation, paid time off), determine attributes of personnel (e.g., work skills, education, certifications, work history), or obtain other attributes of the personnel. Then, the IMS tool may determine the pool of available personnel to be personnel that are currently present in the building, personnel that have addressed the same or similar maintenance issue previously, personnel having requisite authority to address the maintenance issue, or a combination thereof. In addition or alternatively, other considerations may be taken by the IMS tool when determining the pool of available personnel.

At 903, the IMS tool selects, from the pool of available personnel, a personnel based on a predicted performance of the selected personnel. The predicted performance of the personnel may consider one or more of the following attributes: personnel's past performance of successfully fixing similar maintenance issue previously, personnel's level of education or work certification, or other attribute related to a personnel's ability to perform a solution to the maintenance issue. For example, the IMS tool may select the personnel that has experience in successfully fixing the same, or similar, maintenance issue previously.

At 904, the IMS tool assigns the alert tracker ticket to the selected personnel.

At 905, the IMS tool transmits the alert tracker ticket to an electronic account or mobile computing device associated with the personnel. This may include an email, phone number, or internal messenger service associated with the selected personnel.

At 906, the IMS tool may optionally transmit a general alert tracker. The general alert tracker may be transmitted to the available pool of personnel to obtain backup options for addressing the maintenance issue in case the selected personnel cannot.

Various implementations have been specifically described. However, other implementations that include a fewer, or greater, number of features for each of the apparatuses, methods, or other embodiments described herein are also possible.

What is claimed is:

1. A computing device comprising:
a memory configured to store a product tracking register including a plurality of stage registers each representing a different event station, wherein the product tracking register corresponds to a predetermined product tracking process;
a command interface configured to receive user inputs including an initial product count for each stage register in the plurality of stage registers;
a network interface configured to:
receive a pick up confirmation from a mobile computing device, the pick up confirmation corresponding to a first event station; and
receive a drop off confirmation from the mobile computing device, the drop off confirmation corresponding to a second event station; and
a processor configured to:
assign each stage register an initial value corresponding to a respective value included in the initial product count;
update a first stage register corresponding to the first event station to decrease in value by one count based on the pick up confirmation; and
update a second stage register corresponding to the second event station to increase in value by one count based on the drop off confirmation.

2. The computing device of claim 1, wherein the processor is further configured to:
modify the product tracking register to add a deviation stage register representing a deviation event station.

3. The computing device of claim 1, wherein the processor is further configured to:
in response to receiving the drop off confirmation:
generate a new pick up ticket corresponding to the second event station;
receive a second pick up confirmation corresponding to the new pick up ticket; and
in response to receiving the second pick up confirmation, update the second stage register to decrease in value by one count and update a third stage register to increase in value by one count, wherein the third stage register corresponds to a third event station immediately following the second event station.

4. The computing device of claim 1, wherein the value of the first stage register represents a number of bins of product located at the first event station represented by the first stage register.

5. The computing device of claim 1, wherein the processor is further configured to:
receive, from a scaling station, a pre-wash scaling weight for a bin containing product;
determine a pre-wash count of the product contained within the bin based on the pre-wash scaling weight;
receive, from the scaling station, a post-wash scaling weight for the bin containing product; and
determine a post-wash count of the product contained within the bin based on the post-wash scaling weight.

6. The computing device of claim 1, wherein the processor is further configured to:
track a bin of product through the predetermined product tracking process; and
determine the bin of product has finished through the predetermined product tracking process when the bine of product is scanned by a scaling station following processing at a final event station.

7. The computing device of claim 1, wherein each event station represents a different location within a product manufacturing or storing environment corresponding to at least one of a forming machine, a tapping machine, a deflection machine, a work-in-progress location, a scaling machine, or a washing machine.

8. The computing device of claim 1, wherein the processor is further configured to:
confirm a bin of product has been picked up from the first event station according to the pick up confirmation by referencing at least one of a captured video data file including a depiction of the first event station, a radio frequency (RF) sensor data corresponding to the bin of product and the first event station, or a motion sensor data corresponding to the first event station.

9. A computing device comprising:
a memory configured to store a predetermined product tracking process including a plurality of different event stations within a space;
a network interface configured to communicate with a plurality of mobile computing devices; and
a processor configured to:
generate a pick up ticket corresponding to a requested pick up for a bin of product located at a first event station;
receive, from a mobile computing device, a ticket claim corresponding to the pick up ticket;
receive, from the mobile computing device, a pick up confirmation corresponding to the bin of product being picked up from the first event station;
receive, from the mobile computing device, a drop off confirmation corresponding to the bin of product being dropped off at a second event station; and
in response to the drop off confirmation, generating a new pick up ticket corresponding to a requested pick up for a new bin of product located at the second event station.

10. The computing device of claim 9, wherein the processor is further configured to:
determine a location of one or more available mobile computing devices; and
transmit the new pick up ticket to an available mobile computing device closest to the second event station.

11. The computing device of claim 9, wherein the processor is further configured to:
determine a performance score of one or more drivers; and
transmit the new pick up ticket to an available mobile computing device corresponding to a driver having the highest performance score.

12. The computing device of claim 11, wherein the performance score is generated based on at least one of the following driver attributes: historical delivery times or historical delivery performance relating to accuracy of bin delivery.

13. The computing device of claim 9, wherein the processor is further configured to:
detect a maintenance event at one of the event stations included in the predetermined product tracking process; and
generate an alert ticket based on detection of the maintenance event.

14. The computing device of claim 13, wherein the processor is further configured to:
determine a personnel adapted to handle the maintenance event; and
transmit the alert ticket to an electronic account or mobile computing device associated with the personnel.

15. The computing device of claim 9, wherein the processor is further configured to:
track a time between receiving the pick up confirmation and receiving the drop off confirmation; and
storing the tracked time into a personnel profile associated with a driver determined to be driving the bin of product.

16. The computing device of claim 9, wherein the processor is further configured to:
determine a recommended route of travel between the first event station and the second event station; and
transmit the recommended route of travel to the mobile computing device.

17. The computing device of claim 16, wherein the processor is configured to determine the recommended route of travel based on at least one of known obstacles within the space, traffic within the space, or additional tickets for transporting other bins of product claimed on the mobile computing device.

18. The computing device of claim 9, wherein the mobile computing device is attached to a vehicle for transporting the bin of product.

19. A non-transitory memory configured to store machine-readable instructions that, when executed by a machine, causes the machine to:
generate a pick up ticket corresponding to a requested pick up for a bin of product located at a first event station;
receive, from a mobile computing device, a ticket claim corresponding to the pick up ticket;
receive, from the mobile computing device, a pick up confirmation corresponding to the bin of product being picked up from the first event station;
receive, from the mobile computing device, a drop off confirmation corresponding to the bin of product being dropped off at a second event station; and
in response to the drop off confirmation, generating a new pick up ticket corresponding to a requested pick up for a new bin of product located at the second event station.

20. The non-transitory memory of claim 19, further configured to store machine-readable instructions that, when executed by the machine, causes the machine to:
detect a maintenance event at one of the event stations included in a predetermined product tracking process;
generate an alert ticket based on detection of the maintenance event;
determine a personnel adapted to handle the maintenance event; and
transmit the alert ticket to an electronic account or mobile computing device associated with the personnel.
